(19) United States
(12) Patent Application Publication
(10) Pub. No.: US 2008/0029453 A1
(43) Pub. Date: Feb. 7, 2008

(54) Filter Element

(76) Inventors: Helmut Mertens, Riegelsberg (DE); Andreas Schunk, Waldmohr (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/579,798

(22) PCT Filed: May 13, 2005
(86) PCT No.: PCT/EP05/05216

§ 371 Date: Nov. 7, 2006

(30) Foreign Application Priority Data
Jun. 2, 2004 (DE) 10 2004 026 862.2

(51) Int. Cl. B01D 29/11; B01D 35/30; B01D 46/24

(52) U.S. Cl. 210/484

(57) ABSTRACT

The invention relates to a filter element for filtering fluids, which is received in a filter housing and which is configured as a filter candle-type element extending along a longitudinal axis. An inner fluid space of said element is surrounded by a filter material that separates the inner fluid space from an outer fluid space within the filter housing. The body of the filter element, at least in a portion of its length based on its longitudinal axis, has a cross-section in the shape of an orbiform curve (1) deviating from the circular form.

The invention relates to a filter element which can be accommodated in a filter housing for filtering of fluids and which is designed as a filter cartridge which extends along a longitudinal axis in the form of a body in which an inner fluid space is surrounded by filter material which separates the inner fluid space from the outer fluid space within the filter housing.

Filter elements of this type are common. In conjunction with fluid systems of the most varied type, these filter elements are widely used to filter process liquids, pressurized liquids, such as hydraulic oils, liquid fuels and lubricants, for treatment of liquid media and the like. In many cases, in fluid systems in which filter elements are used, only a limited useful space is available for installation or attachment of system parts which contain the pertinent filter elements in the form of filter cartridges. On the other hand, to be able to filter the correspondingly large volumetric flows, a sufficient size of the filter area made available by the filter element or filter elements is necessary.

With respect to these requirements, the object of the invention is to devise a filter element which enables optimization of the ratio of the filtering surface to the required installation space so that system components which are intended for filtering of the pertinent fluids can be made especially space-saving.

As claimed in the invention, this object is achieved by a filter element which has the features of claim 1 in its entirety.

While the filter elements of the prior art are circular, cylindrical or cuboidal, the filter element as claimed in the invention is characterized according to the characterizing part of claim 1 in that it has a special outline in the form of an orbiform curve which deviates from the circular shape on at least part of its length. As is known, the circumference of a circle is equal to the periphery of the corresponding orbiform curve which deviates from the circular shape. Accordingly, in a filter element in which the periphery of the element of the filter cartridge determines the size of the filtering surface, this filtering surface for a cross section in the shape of an orbiform curve is exactly as large as for a cross section in the shape of a circle with the same diameter. The shape of the orbiform curve deviating from the circle shape however makes it possible to house in a given installation space a larger filtering surface than would be possible in a filter element of circular-cylindrical shape. This non-circular shape of the orbiform curve makes it possible to integrate the filter element in a space-saving manner matched to the given boundaries of the installation space such that in a given installation space a larger periphery of the filter element and thus a larger filtering surface are available than would be possible in the installation of a cylindrical filter element at the same installation site.

Preferably the filter element as claimed in the invention has the shape of an orbiform curve in a cross section which is perpendicular to the longitudinal axis.

The cross-sectional shape corresponding to the orbiform curve can optionally be provided in only the longitudinal sections of the body of the filter element which are critical or important to housing the filter element or can extend preferably over the entire length of the body of the filter element.

The cross-sectional shape can be a Reuleaux polygon, for example an orbiform curve, which is formed from an equilateral triangle with circular segments which replace its straight legs.

The subject matter of the invention is also a filter device which is designed to hold at least one filter element, in particular a filter element as claimed in the invention, and which has the features of claim 7.

In that accordingly the outline of the filter housing has a special shape which is selected to match the non-circular cross-sectional shape of at least one filter element which can be held in the housing, it becomes possible to optimize the filter housing, with consideration of both a special cross-sectional shape of the filter element or the filter elements, and also with respect to a given geometry of the available installation space, in the shape of its outline such that space-saving installation of a filtering surface as large as possible is achieved.

The outline of the filter housing can have the shape of an orbiform curve which deviates from the round shape. An especially favorable ratio between the size of the filtering surface and the housing volume can be achieved for example when the filter element to be held in the housing has a matching cross-sectional orbiform shape.

In embodiments in which the outline of the filter housing is round and the filter housing has the shape of a circular cylinder, a good filtering surface/housing volume ratio can be implemented when several filter elements are held in the housing and each have a cross section in the shape of an orbiform curve which deviates from the round shape.

Of the filter elements as claimed in the invention which are made in this way, four orbiform filter elements as claimed in the invention can be accommodated in a circular-cylindrical filter housing which is dimensioned for holding three conventional filter elements which are circular in outline. Since the periphery of the circular-cylindrical, conventional filter element and of the corresponding orbiform filter element as claimed in the invention is the same in each case, that is, each of the three known filter elements makes available the same filtering surface as each of the four filter elements as claimed in the invention, thus the total filtering surface when using the orbiform filter elements as claimed in the invention is one third larger than when using known filter elements.

The invention will be detailed below using one embodiment shown in the drawings.

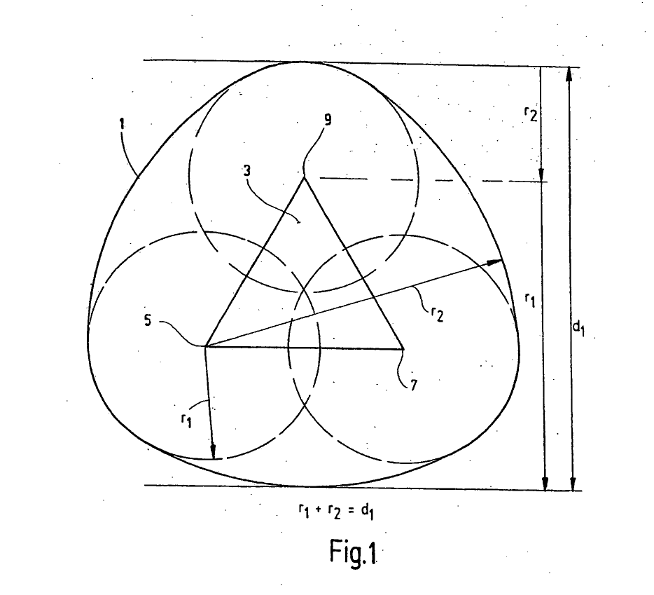

FIG. 1 shows the geometry of a Reuleaux orbiform curve based on an equilateral triangle and

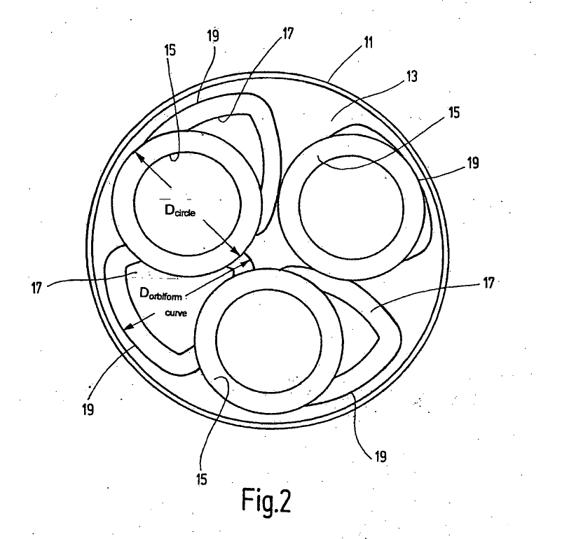

FIG. 2 shows a highly schematically simplified representation in illustration of the installation situation of filter elements with a circular cross section and of filter elements with a cross section in the shape of an orbiform curve in a circular-cylindrical filter housing.

FIG. 1 shows details of a Reuleaux orbiform curve with an outline designated as 1. The orbiform curve is based on an equilateral triangle 3 with corners 5, 7, and 9, each corner being the center of a circle with radius r₁ and an arc with radius r₂. These two radii are shown in the figure only proceeding from the corner 5. The magnitude of the radius r₂ is in a ratio to the radius r₁ such that the corresponding arc tangentially adjoins the circle with a radius r₁ and thus the closed outline designated as 1 in FIG. 1 results.

The diameter d₁ of the orbiform curve formed in this way corresponds to the sum of the radii r₁ and r₂. The periphery of the orbiform curve, i.e., the length of the outline 1, has the same dimension as the circumference of a circle with diameter d₁.

In FIG. 2, in which the wall of the filter housing which has a round base surface 13 is designated as 11, the installation position of three filter elements 15 with a circular cross section is shown. At the same time, the installation position of four orbiform filter elements 17 is shown, with a cross-sectional shape which corresponds to the Reuleaux orbiform curve shown in FIG. 1. In this connection, as shown in FIG. 2, the circular diameter of the filter element 15 is equal to the diameter of the orbiform curve of the filter element 17. As is to be seen, in the filter housing 11 which is dimensioned for three round filter elements 15, four orbiform filter elements 17 can be accommodated.

As is also to be seen from FIG. 2, the orbiform filter elements 17 are each installed in the filter housing 11 in a positional alignment such that they are immediately adjacent to wall 11 of the filter housing with the central region 19 of their outer side which is arched in the shape of an arc with a larger radius of curvature.

1. Filter element (17) which can be accommodated in a filter housing (11) for filtering of fluids and which is designed as a filter cartridge which extends along a longitudinal axis in the form of a body in which an inner fluid space is surrounded by filter material which separates the inner fluid space from the outer fluid space within the filter housing, characterized in that the body of the filter element (17) has a cross section in the shape of a orbiform curve (1) which deviates from the circular shape on at least one part of its length relative to the longitudinal axis.

2. The filter element as claimed in claim 1, wherein it has the shape of an orbiform curve (1) in a cross section perpendicular to the longitudinal axis.

3. The filter element as claimed in claim 1, wherein the cross section has the shape of an orbiform curve (1) in preferred longitudinal sections of the body of the filter element.

4. The filter element as claimed in claim 1, wherein the cross section of the body of the filter element has the shape of an orbiform curve (1) over its entire length.

5. The filter element as claimed in claim 1, wherein the cross section of the body of the filter element has the shape of a Reuleaux polygon (1).

6. The filter element as claimed in claim 5, wherein the cross-sectional shape is an orbiform curve (1) which is formed from an equilateral triangle with circular segments which replace its straight legs.

7. Filter device for holding at least one filter element, especially one (17) as claimed in claim 1, with a filter housing (11) in the shape of a hollow body with an outline which defines the size of the interior which is available for accommodating at least one filter element (17), wherein the outline of the filter housing (11) has a shape which is selected to match the non-circular cross-sectional shape of at least one filter element (17).

8. The filter device as claimed in claim 7, wherein the outline of the filter housing (11) has the shape of a non-circular orbiform curve.

9. The filter device as claimed in claim 7, wherein the outline of the filter housing (11) is circular and the filter housing (11) has the shape of a circular cylinder.

10. Filter device as claimed in claim 9 for holding filter elements (17) as claimed in claim 6, wherein there are four filter elements (17) next to one another in the interior of the filter housing (11).

11. The filter device as claimed in claim 10, wherein the central area (19) of the outer side of the filter elements (17) which is arched in an arc shape with the larger radius of curvature of an orbiform curve (1) is nearest the inside wall of the circular-cylindrical filter housing (11).
